(19) United States
(12) Patent Application Publication
(10) Pub. No.: US 2012/0288696 A1
(43) Pub. Date: Nov. 15, 2012

(54) Multi-Layer Elastic Films

(76) Inventor: Shawn E. Jenkins, Duluth, GA (US)

(21) Appl. No.: 13/103,544

(22) Filed: May 9, 2011

(51) Int. Cl. B32B 7/02; B32B 27/12; B29C 65/00; B32B 27/08

(52) U.S. Cl. 428/216; 428/516; 442/398; 156/152

(57) ABSTRACT

The present invention is directed to a multi-microlayer film that includes a plurality of alternating coextruded first and second microlayers, wherein the first microlayers include an elastomeric polyolefin polymer composition, and further wherein the second microlayers include a styrenic block copolymer composition. The multi-microlayer films provide good elastic performance at relatively low cost.

### BACKGROUND OF THE INVENTION

Elastic sheet materials are commonly incorporated into products (e.g., diapers, training pants, garments, etc.) to improve their ability to better fit the contours of the body. For example, an elastic composite may be formed from an elastic sheet material and one or more nonwoven web facings. The nonwoven web facing may itself be extensible. Alternatively, the nonwoven web facing may be joined to the elastic sheet material while the elastic sheet material is in a stretched condition so that the nonwoven web facing can gather between the locations where it is bonded to the elastic sheet material when it is relaxed. The resulting elastic composite is stretchable to the extent that the nonwoven web facing gathered between the bond locations allows the elastic film to elongate.

The elastic sheet materials desirably have good elastic properties in that the elastic sheet materials will maintain tension over a period of time. For example, in an elastic waistband it is desirable that the waistband maintain its tension while being worn, i.e., reduced tension may cause the waistband and product to begin to sag. As can be imagined, there is generally a direct correlation between cost and performance of elastic polymers useful for making elastic sheet materials, i.e., higher performing materials cost more. It is, therefore, desirable to achieve good elastic performance while maintaining low cost, i.e., high value.

As such, a need exists for new elastic materials that provide good value in elastic performance.

### SUMMARY OF THE INVENTION

The present invention is directed to a multi-microlayer film that includes a plurality of alternating coextruded first and second microlayers, wherein the first microlayers include an elastomeric polyolefin polymer composition, and further wherein the second microlayers include a styrenic block copolymer composition.

In one aspect, the elastomeric polyolefin polymer composition includes from about 40 wt. % to about 95 wt. % of a metallocene catalyzed elastomer. In some embodiments, the elastomeric polyolefin polymer composition comprises from about 40 wt.% to about 95 wt.% of a polymer selected from the group consisting of polyethylene, polypropylene and other alpha-olefin homopolymers and copolymers having density less than about 0.89 grams/cc. In other embodiments, the styrenic block copolymer composition comprises from about 5 wt. % to about 60 wt. % of a styrenic block copolymer. In further embodiments, the elastomeric polyolefin polymer composition comprises from about 40 wt.% to about 95 wt.% of the multi-microlayer film and the styrenic block copolymer composition comprises from about 5 wt. % to about 60 wt. % of the multi-microlayer film.

In another aspect, each microlayer has a thickness of from about 0.05 microns to about 150 microns. In some embodiments, the multi-microlayer film has a thickness from about 5 to about 500 microns. In other embodiments, the multi-microlayer film comprises from about 8 to about 4,000 microlayers.

In a further aspect, the multi-microlayer film has an MD modulus greater than 20% greater than a non-layered film with the same basis weight of elastomeric polyolefin polymer and styrenic block copolymer. In some embodiments, the multi-microlayer film has a CD modulus greater than 20% greater than a non-layered film with the same basis weight of elastomeric polyolefin polymer and styrenic block copolymer.

In an even further aspect, a nonwoven composite includes a nonwoven material and the multi-microlayer film described above laminated to the nonwoven material. In some embodiments, an absorbent article includes an outer cover, a bodyside liner joined to the outer cover, and an absorbent core positioned between the outer cover and the bodyside liner, wherein the absorbent article includes the nonwoven composite described above.

In another embodiment, a method of making a multi-microlayer film, the method comprising the steps of:
providing an elastomeric polyolefin polymer composition and a styrenic block copolymer composition;
coextruding the elastomeric polyolefin polymer composition and the styrenic block copolymer composition;
splitting the elastomeric polyolefin polymer composition and the styrenic block copolymer composition into multiple alternating layers; and,
forming the multiple alternating layers into a multi-microlayer film having alternating coextruded microlayers.

In one aspect, the elastomeric polyolefin polymer composition of the method includes from about 10 wt. % to about 50 wt. % of a metallocene catalyzed elastomer. In one embodiment, the styrenic block copolymer composition comprises from about 10 wt. % to about 50 wt. % of a styrenic block copolymer. In another embodiment, the elastomeric polyolefin polymer composition comprises from about 50 wt.% to about 90 wt.% of the multi-microlayer film and the styrenic block copolymer composition comprises from about 10 wt. % to about 50 wt. % of the multi-microlayer film.

In another aspect, each microlayer of the method has a thickness of from about 0.05 microns to about 150 microns. In some embodiments, the multi-microlayer film has a thickness from about 5 to about 500 microns. In other embodiments, the multi-microlayer film comprises from about 8 to about 4,000 microlayers.

In a further aspect, the multi-microlayer film of the method has an MD modulus greater than 20% greater than a non-layered film with the same basis weight of elastomeric polyolefin polymer and styrenic block copolymer. In some embodiments, the multi-microlayer film has an CD modulus greater than 20% greater than a non-layered film with the same basis weight of elastomeric polyolefin polymer and styrenic block copolymer.

### BRIEF DESCRIPTION OF THE DRAWINGS

FIG. 1 is a plan view of a coextrusion system for making a microlayer polymer film in accordance with an embodiment of this invention.

FIG. 2 is a schematic diagram illustrating a multiplying die element and the multiplying process used in the coextrusion system illustrated in FIG. 1.

FIG. 3 is scanning electron microscopy (SEM) micrographs showing representative cross-sectional views of various films.

FIG. 4 is a chart depicting tensile properties of various sample films.

FIG. 5 is a chart depicting hysteresis properties of various sample films.

### DETAILED DESCRIPTION OF THE INVENTION

The present invention encompasses an elastic multi-microlayer polymer film that has sufficient elastic properties for use in applications such as absorbent personal care products. Below is a detailed description of embodiments of this invention including a method for coextruding the microlayer polymer film, followed by a description of uses and properties of the film and particular examples of the film.

The present invention is directed to elastic multi-microlayer polymer films which are made by coextrusion of alternating layers of a melt extrudable elastomeric polyolefin polymer composition and a melt extrudable styrenic block copolymer composition. Suitable polymers for use in this invention are stretchable in a solid state.

This invention includes multi-microlayer films composed of a multi-microlayer assembly of elastomeric polyolefin polymer composition microlayers and microlayers of a styrenic block copolymer composition. By definition, “multi-microlayer” means a film having a plurality of alternating layers wherein, based upon the process by which the film is made, each microlayer becomes partially integrated or adhered with the layers above and below the microlayer. This is in contrast to “multi-layer” films wherein conventional co-extruded film-making equipment forms a film having only a few layers and wherein each layer is generally separate and distinct from each other layer than in multi-microlayer films.

The multi-microlayer films are designed to have elastomeric characteristics with enhanced softness and flexibility, reduced modulus, improved toughness, and enhanced recovery for use as a film component in personal and health care products. These films are useful in the creation of articles that are soft and elastomeric. By definition, “elastomeric” or “enhanced recovery” means the ability of the film or article to be stretched by a stretching force from its original length and to retract rapidly upon release of the stretching force to approximately the original length.

The multi-microlayer polymer film of this invention comprises a plurality of coextruded microlayers which form a laminate structure. The coextruded microlayers include a plurality of first layers comprising an elastomeric polyolefin polymer composition and a plurality of second layers comprising a styrenic block copolymer composition. The plurality of first layers and plurality of the second polymer layers are arranged in a series of parallel repeating laminate units. Each laminate unit comprises at least one of the first layers and at least one of the second layers. In some embodiments, each laminate unit has one second layer laminated to a first layer so that the coextruded microlayers alternate between first layers and second layers, i.e., an A/B arrangement. Alternatively, the laminate unit may have three or more layers, for example, an A/B/A arrangement.

In the case of the A/B laminate unit, the resulting multi-microlayered film is arranged as A/B/A/B . . . A/B, where one side is always A and the other side is always B.

In the case of the A/B/A arrangement, the resulting multi-microlayered film is arranged as A/B/A/A/B/A/AB/A . . . A/B/A. In this case, both sides of the multi-microlayered film are always A. In addition, there are adjacent A/A layers imbedded in the multi-microlayered film. When counting microlayers, adjacent layers of the same composition are counted as one layer. For instance, an A/A arrangement is counted as only one layer.

During stretching the multilayer film may change dimensions in the direction perpendicular to the stretching direction and in the z-direction (thickness direction). Typically it shrinks in the direction perpendicular to the stretch direction and shrinks in the z-direction.

Each microlayer in the polymer film has a thickness from about 0.05 microns to about 150 microns. In another embodiment, each microlayer has a thickness that does not exceed about 100 microns. In another embodiment each microlayer has a thickness that does not exceed about 50 microns. More particularly, each microlayer has a thickness that is not less than 0.5 microns. In still another embodiment, each microlayer has a thickness that is not less than about 1 micron.

In still another embodiment, the microlayers of the film have a thickness from about 0.1 microns to about 90 microns. Microlayers, however, form laminate films with high integrity and strength because they do not substantially delaminate after microlayer coextrusion due to the partial integration or strong adhesion of the microlayers. Microlayers enable combinations of two or more layers of into a monolithic film with a strong coupling between individual layers. The term “monolithic film” as used herein means a film that has multiple layers which adhere to one another and function as a single unit.

The number of microlayers in the film of this invention varies broadly from about 8 to about 4000 in number, and in another embodiment from about 16 to about 2048 in number. However, based upon the thickness of each microlayer, the number of microlayers in the film is determined by the desired overall film thickness. In one embodiment, the multi-microlayer films have a thickness of from about 5 to about 500 microns. In another embodiment, the films have a thickness of from about 10 to about 300 microns. In yet another embodiment, the films have a thickness of from about 40 to about 200 microns. Basis weight of the films may range in some embodiments from about 10 gsm (grams per square meter) to about 100 gsm, in other embodiments from about 30 gsm to about 80 gsm.

The term “melt-extrudable polymer” as used herein means a thermoplastic material having a melt flow rate (MFR) value of not less than about 0.1 grams/10 minutes, based on ASTM D1238. More particularly, the MFR value of suitable melt-extrudable polymers ranges from about 0.1 g/10 minutes to about 100 g/10 minutes. In another embodiment, the MFR value of suitable melt-extrudable polymers ranges from about 0.2 g/10 minutes to about 50 g/10 minutes. In yet another embodiment the MFR value ranges from about 0.4 g/10 minutes to about 50 g/10 minutes to provide desired levels of processability.

Still more particularly, suitable melt-extrudable elastic polymers for use in this invention are stretchable and elastic in solid state to allow stretching and recovery of the multi-microlayered film. Stretching in solid state means stretching at a temperature below the melting point of the thermoplastic polymer.

The engineering tensile fracture stress (force at peak load divided by the cross-sectional area of the original specimen), tested in the machine direction orientation according to ASTM-D882-02, is useful to determine the strength of the film. In some embodiments the tensile fracture stress may range from about 250 to 1000 psi. In other embodiments the tensile fracture stress may range from about 700 to 1500 psi. In another embodiment the tensile fracture stress may range from about 800 to about 2500 psi.

Some of the microlayers of the multi-microlayer film are desirably composed of a thermoplastic, melt extrudable elastomeric polyolefin polymer. There exists a wide variety of melt-extrudable elastomeric polyolefin polymers suitable for use with the present invention. The microlayers can be made from any elastic polyolefin polymer suitable for film formation. Film forming elastic polyolefin polymers suitable for use with the present invention, alone or in combination with other polymers, include, by way of example only, elastic polyolefins made by “metallocene”, “constrained geometry” or “single-site” catalysts. Suitable olefinic elastomers include polyethylene, polypropylene and other alpha-olefin homopolymers and copolymers having density less than about 0.89 grams/cc. Examples of such catalysts and polymers are described in U.S. Pat. No. 5,472,775 to Obijeski et al.; U.S. Pat. No. 5,451,450 to Erderly et al.; U.S. Pat. No. 5,278,272 to Lai et al.; U.S. Pat. No. 5,272,236 to Lai et al.; U.S. Pat. No. 5,204,429 to Kaminsky et al.; U.S. Pat. No. 5,539,124 to Etherton et al.; and U.S. Pat. No. 5,554,775 to Krishnamurti et al.; the entire contents of which are incorporated herein by reference. The aforesaid patents to Obijeski and Lai teach exemplary polyolefin elastomers and, in addition, exemplary low density polyethylene elastomers are commercially available from The Dow Chemical Company under the trade name AFFINITY, from ExxonMobil Chemical Company, under the trade name EXACT, and from Dupont Dow Elastomers, L.L.C. under the trade name ENGAGE. Moreover, exemplary propylene-ethylene copolymer plastomers and elastomers are commercially available from The Dow Chemical Company under the trade name VERSIFY and ExxonMobil Chemical Company under the trade name VISTAMAXX.

Some of the microlayers of the film of this invention are desirably composed of an elastic block copolymer composition. Suitable thermoplastic block copolymer elastomers include those made from block copolymers having the general formula A-B-A′ where A and A′ are each a thermoplastic polymer endblock which contains a styrenic moiety such as a poly(vinyl arene) and where B is an elastomeric polymer midblock such as a conjugated diene or a lower alkene polymer. Further, exemplary block copolymers include A-B-A-B tetrablock polymers having an isoprene monomer unit hydrogenated to a substantially poly(ethylene-propylene) monomer unit such as a styrene-poly(ethylene-propylene)-styrene-poly(ethylene-propylene) elastomeric block copolymer. Examples of such styrene-olefin block copolymers include styrene-(ethylene-butylene), styrene-(ethylene-propylene), styrene-(ethylene-butylene)-styrene, styrene-(ethylene-propylene)-styrene, styrene-(ethylene-butylene)-styrene-(ethylene-butylene), styrene-(ethylene-propylene)-styrene-(ethylene-propylene), and styrene-ethylene-(ethylene-propylene)-styrene. These block copolymers may have a linear, radial or star-shaped molecular configuration. As specific examples, exemplary elastomers can comprise (polystyrene/poly(ethylene-butylene)/polystyrene) block copolymers available from the Kraton Polymers LLC under the trade name KRATON as well as polyolefin/KRATON blends such as those described in U.S. Pat. Nos. 4,663,220, 4,323,534, 4,834,738, 5,093,422, 5,304,599, and 5,332,613, the entire contents of the aforesaid references are incorporated herein by reference. Still other suitable copolymers include the S-I-S and S-B-S elastomeric copolymers available from Dexco Polymers of Houston, Tex. under the trade designation VECTOR®. Other additives may also be incorporated into the microlayers, such as melt stabilizers, crosslinking catalysts, pro-rad additives, processing stabilizers, heat stabilizers, light stabilizers, antioxidants, heat aging stabilizers, whitening agents, antiblocking agents, bonding agents, tackifiers, viscosity modifiers, etc. Examples of suitable tackifier resins may include, for instance, hydrogenated hydrocarbon resins. REGALREZ™ hydrocarbon resins are examples of such hydrogenated hydrocarbon resins, and are available from Eastman Chemical. Other tackifiers are available from ExxonMobil under the ESCOREZ™ designation. Viscosity modifiers may also be employed, such as polyethylene wax (e.g., EPOLENE™ C-10 from Eastman Chemical). Phosphite stabilizers (e.g., IRGAFOS available from Ciba Specialty Chemicals of Terrytown, N.Y. and DOVERPHOS available from Dover Chemical Corp. of Dover, Ohio) are exemplary melt stabilizers. In addition, hindered amine stabilizers (e.g., CHIMASSORB available from Ciba Specialty Chemicals) are exemplary heat and light stabilizers. Further, hindered phenols are commonly used as an antioxidant in the production of microlayer films. Some suitable hindered phenols include those available from Ciba Specialty Chemicals of under the trade name “Irganox®”, such as Irganox® 1076, 1010, or E 201. Moreover, bonding agents may also be added to the film to facilitate bonding of the film to additional materials (e.g., nonwoven web). Typically, such additives (e.g., tackifier, antioxidant, stabilizer, etc.) are each present in an amount from about 0.001 wt.% to about 25 wt.%, in some embodiments, from about 0.005 wt.% to about 20 wt.%, and in some embodiments, from 0.01 wt.% to about 15 wt.% of the film.

Breathability of the microlayer films may be achieved by incorporating a particulate filler into layers of the microlayer film. Particulate filler material creates discontinuity in the microlayers to provide pathways for water vapor to move through the film. Particulate filler material may also enhance the ability of the microlayer film to absorb or immobilize fluid, enhance biodegradation of the film, provide porosity-initiating debonding sites to enhance the formation of pores when the microlayer film is stretched, improve processability of the microlayer film and reduce production cost of the microlayer film. In addition, lubricating and release agents may facilitate the formation of microvoids and the development of a porous structure in the film during stretching of the film and may reduce adhesion and friction at filler-resin interface. Surface active materials such as surfactants coated on the filler material may reduce the surface energy of the film, increase hydrophilicity of the film, reduce film stickiness, provide lubrication, or reduce the coefficient of friction of the film.

Suitable filler materials may be organic or inorganic, and are desirably in a form of individual, discrete particles. Suitable inorganic filler materials include metal oxides, metal hydroxides, metal carbonates, metal sulfates, various kinds of clay, silica, alumina, powdered metals, glass microspheres, or vugular void-containing particles. Particularly suitable filler materials include calcium carbonate, barium sulfate, sodium carbonate, magnesium carbonate, magnesium sulfate, barium carbonate, kaolin, carbon, carbon black, graphite, graphene, and other predominantly carbonaceous solids, calcium oxide, magnesium oxide, aluminum hydroxide, and titanium dioxide. Still other inorganic fillers may include those with particles having higher aspect ratios such as talc, mica and wollastonite. Suitable organic filler materials include, for example, latex particles, particles of thermoplastic elastomers, pulp powders, wood powders, cellulose derivatives, chitin, chitosan powder, powders of highly crystalline, high melting polymers, beads of highly crosslinked polymers, organosilicone powders, and powders or particles of super absorbent polymers, such as polyacrylic acid and the like, as well as combinations and derivatives thereof. Particles of super absorbent polymers or other superabsorbent materials may provide for fluid immobilization within the microlayer film. These filler materials may improve toughness, softness, opacity, vapor transport rate (breathability), biodegradability, fluid immobilization and absorption, skin wellness, and other beneficial attributes of the microlayer film.

Surfactants may increase the hydrophilicity and wettability of the film, and enhance the water vapor permeability of the film, and may improve filler dispersion in the polymer. For example, surfactant or the surface active material may be blended with the polymers forming elastomer layers or otherwise incorporated onto the particulate filler material before the filler material is mixed with the elastomeric polymer. Suitable surfactants or surface active materials may have a hydrophile-lipophile balance (HLB) number from about 6 to about 18. Desirably, the HLB number of the surface active material or a surfactant ranges from about 8 to about 16, and more desirably ranges from about 12 to about 15 to enable microlayer wettability by aqueous fluids. When the HLB number is too low, the wettability may be insufficient and when the HLB number is too high, the surface active material may have insufficient adhesion to the polymer matrix of the elastomeric layer, and may be too easily washed away during use. The surfactant modification or treatment of the microlayer film or the components of the microlayer film may provide a water contact angle of less than 90 degrees for the microlayer film. Preferably surfactant modification may provide a water contact angle of less than 70 degrees. For example, incorporation of the Dow Corning 193 surfactant into the film components may provide a water contact angle of about 40 degrees. A number of commercially available surfactants may be found in McMcutcheon's Vol. 2; Functional Materials, 1995.

Suitable surfactants and surface-active materials for blending with the polymeric components of the microlayer film or treating the particulate filler material include silicone glycol copolymers, ethylene glycol oligomers, acrylic acid, hydrogen-bonded complexes, carboxylated alcohol, ethoxylates, various ethoxylated alcohols, ethoxylated alkyl phenols, ethoxylated fatty esters, stearic acid, behenic acid, and the like, as well as combinations thereof.

The surface activate material is suitably present in the respective microlayer in an amount from about 0.5 to about 20% by weight of the microlayer. Even more particularly, the surface active material is present in the respective microlayer in an amount from about 1 to about 15% by weight of the microlayer, and more particularly in an amount from about 2 to about 10% by weight of the microlayer. The surface activate material may be suitably present on the particulate in an amount of from about 1 to about 12% by weight of the filler material. The surfactant or surface active material may be blended with suitable polymers to form a concentrate. The concentrate may be mixed or blended with polymers forming the alternate microlayers.

The multi-microlayer film may further include one or two additional skin layer(s) on the outer surfaces of the multi-microlayer film. The skin layer(s) may enhance breathability, impart electrostatic dissipation, stabilize the film during extrusion, or provide other benefits to the overall structure. The skin layer(s) may generally be formed from any film-forming polymer. If desired, the skin layer(s) may contain a softer, lower melting polymer or polymer blend that renders the skin layer(s) more suitable as heat seal bonding layers for thermally bonding the film to a nonwoven web. In most embodiments, the skin layer(s) are formed from a film-forming, thermoplastic, melt extrudable polymers such as are known in the art.

In such embodiments, the skin layer(s) may contain filler particles as described above, or the layer(s) may be free of filler. When a skin layer is free of filler, one objective is to alleviate the build-up of filler at the extrusion die lip that may otherwise result from extrusion of a filled film. When a skin layer contains filler, one objective is to provide a suitable bonding layer without adversely affecting the overall breathability of the film.

In one particular embodiment, the skin layer(s) may employ a lubricant that may migrate to the surface of the film during extrusion to improve its processability. The lubricants are typically liquid at room temperature and substantially immiscible with water. Non-limiting examples of such lubricants include oils (e.g., petroleum based oils, vegetable based oils, mineral oils, natural or synthetic oils, silicone oils, lanolin and lanolin derivatives, kaolin and kaolin derivatives, and so forth); esters (e.g., cetyl palmitate, stearyl palmitate, cetyl stearate, isopropyl laurate, isopropyl myristate, isopropyl palmitate, and so forth); glycerol esters; ethers (e.g., eucalyptol, cetearyl glucoside, dimethyl isosorbicide polyglyceryl-3 cetyl ether, polyglyceryl-3 decyltetradecanol, propylene glycol myristyl ether, and so forth); alkoxylated carboxylic acids; alkoxylated alcohols; fatty alcohols (e.g., octyldodecanol, lauryl, myristyl, cetyl, stearyl and behenyl alcohol, and so forth); etc. In one particular embodiment, the lubricant is alpha tocephrol (vitamin E) (e.g., Irganox® E 201). Other suitable lubricants are described in U.S. Patent Application Publication No. 2005/0258562 to Wilson, et al., which is incorporated herein in its entirety by reference thereto for all purposes. Organopolysiloxane processing aids may also be employed that coat the metal surface of melt-processing equipment and enhance ease of processing. Examples of suitable polyorganosiloxanes are described in U.S. Pat. Nos. 4,535,113; 4,857,593; 4,925,890; 4,931,492; and 5,003,023, which are incorporated herein in their entirety by reference thereto for all purposes. A particular suitable organopolysiloxane is SILQUEST® PA-1, which is commercially available from GE Silicones.

The thickness of the skin layer(s) is generally selected so as not to substantially impair the elastic properties of the film. To this end, each skin layer may separately comprise from about 0.5% to about 15% of the total thickness of the film, and in some embodiments from about 1% to about 10% of the total thickness of the film. For instance, each skin layer may have a thickness of from about 0.1 to about 10 microns, in some embodiments from about 0.5 to about 5 microns, and in some embodiments, from about 1 to about 2.5 microns.

The microlayer films may be post-processed to stabilize the film structure. The post processing may be done by a thermal point or pattern bonding, by embossing, by sealing edges of the film using heat or ultrasonic energy, or by other operations known in the art. One or more nonwoven webs may be laminated to the film with microlayers to improve strength of the film, its tactile properties, appearance, or other beneficial properties of the film. The nonwoven webs may be spunbond webs, meltblown webs, bonded carded webs, airlaid or wet laid webs, or other nonwoven webs known in the art.

The films may also be perforated before stretching or after stretching. The perforations may provide z-directional channels for fluid access, absorption and transport, and may improve vapor transport rate. Perforation may be accomplished by punching holes using pins of varying diameter, density, and configuration, which may be arranged into a pattern desired for a specific application of the film. The pins to punch holes and perforate the film may be optionally heated. Other methods known in the art may be also used to perforate the film; for example, high speed and intensity water jets, high intensity laser beams, or vacuum aperture techniques may be used to generate a desired pattern of holes in the film of the invention. The holes or perforation channels may penetrate through the entire thickness of the film or may partially perforate the film to a specified channel depth.

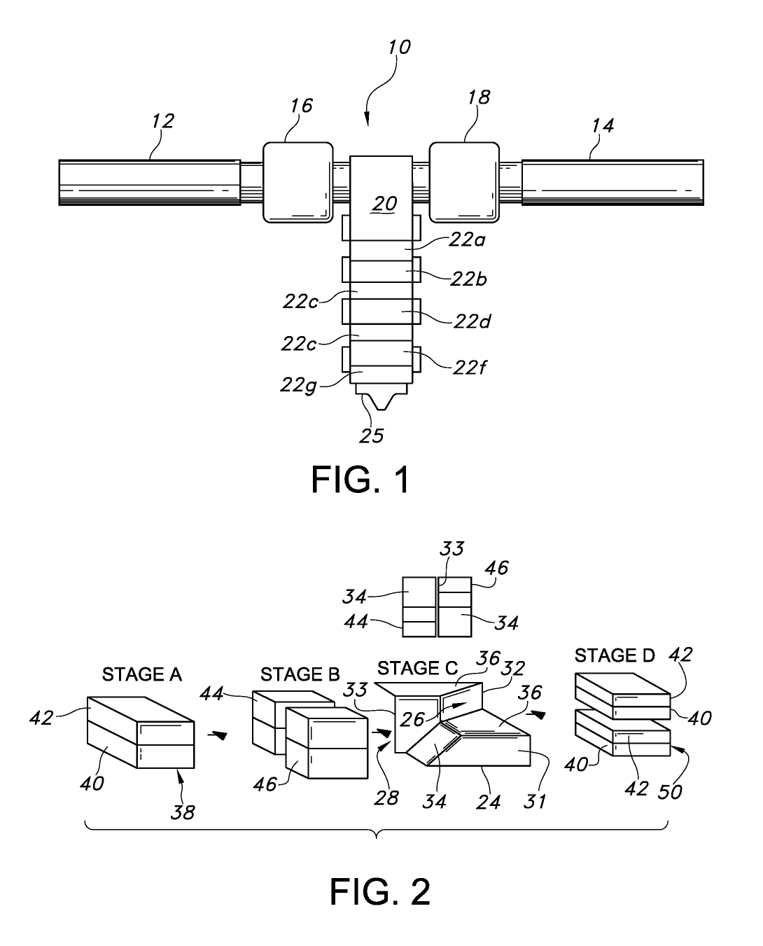

A suitable method for making the microlayer film of this invention is a microlayer coextrusion process wherein two or more polymers are coextruded to form a laminate with two or more layers, which laminate is then manipulated to multiply the number of layers in the film. FIG. 1 illustrates a coextrusion device 10 for forming microlayer films. This device includes a pair of opposed single-screw extruders 12 and 14 connected through respective metering pumps 16 and 18 to a coextrusion block 20. A plurality of multiplying elements 22a-g extends in series from the coextrusion block perpendicularly to the single-screw extruders 12 and 14. Each of the multiplying elements includes a die element 24 disposed in the melt flow passageway of the coextrusion device. The last multiplying element 22g is attached to a discharge nozzle 25, for example, a film die, through which the final product extrudes. While single-screw extruders are shown, the present invention may also use twin-screw extruders to form the films of the present invention.

A schematic diagram of the coextrusion process carried out by the coextrusion device 10 is illustrated in FIG. 2. FIG. 2 also illustrates the structure of the die element 24 disposed in each of the multiplying elements 22a-g. Each die element 24 divides the melt flow passage into two passages 26 and 28 with adjacent blocks 31 and 32 separated by a dividing wall 33. Each of the blocks 31 and 32 includes a ramp 34 and an expansion platform 36. The ramps 34 of the respective die element blocks 31 and 32 slope from opposite sides of the melt flow passage toward the center of the melt flow passage. The expansion platforms 36 extend from the ramps 34 on top of one another.

To make a microlayer film using the coextrusion device 10 illustrated in FIG. 1, an elastomeric polyolefin polymer composition, is extruded through the first single screw extruder 12 into the coextrusion block 20. Likewise, a styrenic block copolymer composition, is extruded through the second single screw extruder 14 into the same coextrusion block 20. In the coextrusion block 20, a melt laminate structure 38 such as that illustrated at stage A in FIG. 2 is formed with the elastomeric polyolefin polymer composition forming a layer on top of a layer of styrenic block copolymer composition.

The coextrusion block 20 can be configured to to provide an “asymmetrical” side-by-side configuration of the polymers from the two extruders 12, 14 (i.e., A/B configuration) or a “symmetrical” skin/core/skin configuration (i.e., A/B/A). Other starting structures may be coextruded from the feedblock as will be appreciated by one skilled in the art. For example, in another embodiment, a third tie layer “C” (not shown) may be extruded by a third extruder (not shown) between “A” and “B” layers via an extrusion block configured to provide an A/C/B arrangement, or, alternatively, an A/C/B/C arrangement. Coextrusion blocks configured to provide an “asymmetric” flow such as A/B will likewise produce an “asymmetric” micro-multilayer film. That is, one outer (terminating) surface will always be composed of “A”, and the other terminating surface will always be predominantly composed of “B”. Similarly, extrusion blocks configured to provide a “symmetric” A/B/A flow element will produce a “symmetric” micro-multilayer film. That is, both terminating layers will be composed of “A”.

This can be utilized if polymer A or B has some preferential surface property, such as wettability, electrostatic discharge, surface tack, or some other attribute of importance to elastic film laminates.

The melt laminate is then extruded through the series of multiplying elements 22a-g to form a multi-layer microlaminate with the layers alternating between the elastomeric polyolefin polymer composition and the styrenic block copolymer composition. As the two-layer melt laminate is extruded through the first multiplying element 22a, the dividing wall 33 of the die element 24 splits the melt laminate 38 into two halves 44 and 46 each having a layer of elastomeric polyolefin polymer composition 40 and a layer of the styrenic block copolymer composition 42. This is illustrated at stage B in FIG. 2. As the melt laminate 38 is split, each of the halves 44 and 46 are forced along the respective ramps 34 and out of the die element 24 along the respective expansion platforms 36. This reconfiguration of the melt laminate is illustrated at stage C in FIG. 2. When the melt laminate 38 exits from the die element 24, the expansion platform 36 positions the split halves 44 and 46 on top of one another to form a four-layer melt laminate 50 having, in parallel stacking arrangement, an elastomeric polyolefin polymer composition layer, a layer of the styrenic block copolymer composition, an elastomeric polyolefin polymer composition layer and a layer of the styrenic block copolymer composition in laminate form. This process is repeated as the melt laminate proceeds through each of the multiplying elements 22b-g. When the melt laminate is discharged through the discharge nozzle 25, the melt laminate forms a film having from about 4 to about 1000 microlayers, depending on the number of multiplying elements.

The foregoing microlayer coextrusion device and process is described in more detail in an article Mueller et al., entitled Novel Structures By Microlayer Extrusion-Talc-Filled PP, PC/SAN, and HDPE-LLDPE, Polymer Engineering and Science, Vol. 37, No. 2, 1997. Similar processes are described in U.S. Pat. No. 3,576,707 and U.S. Pat. No. 3,051,453, the disclosures of which are expressly incorporated herein by reference. Other processes known in the art to form multi-microlayer film may also be employed, e.g., coextrusion processes described in W. J. Schrenk and T. Ashley, Jr., “Coextruded Multilayer Polymer Films and Sheets, Polymer Blends”, Vol. 2, Academic Press, New York (1978).

The relative thickness of the microlayers of the film made by the foregoing process may be controlled by varying the feed ratio of the polymers into the extruders, thus controlling the constituent volume fraction. In addition, one or more extruders may be added to the coextrusion device to increase the number of different polymers in the microlayer film. For example, a third extruder may be added to add a tie layer to the film.

When filler is used in any of the layers, the microlayer film may be made breathable by subjecting the film to a selected plurality of stretching operations, such as uniaxial stretching operation or biaxial stretching operation. Stretching operations may provide microporous microlayer film with a distinctive porous microlayered morphology, may enhance water vapor transport through the film, and may improve water access, and enhance degradability of the film. In a first embodiment, the film is stretched from about 100 to about 1500 percent of its original length. In another embodiment, the film is stretched from about 100 to about 500 percent of its original length.

The parameters during stretching operations include stretching draw ratio, stretching strain rate, and stretching temperature. Stretching temperatures may be in the range of from about 15° C. to about 100° C. In another embodiment, stretching temperatures may be in the range of from about 25° C. to about 85° C. During stretching operation, the multi-microlayer film sample may optionally be heated to provide a desired effectiveness of the stretching.

In one particular aspect of the invention, the draw or stretching system may be constructed and arranged to generate a draw ratio which is not less than about 2 in the machine and/or transverse directions. The draw ratio is the ratio determined by dividing the final stretched length of the microlayer film by the original unstretched length of the microlayer film along the direction of stretching. The draw ratio in the machine direction (MD) should not be less than about 2. In another embodiment, the draw ratio is not less than about 2.5 and in yet another embodiment is not less than about 3.0. In another aspect, the stretching draw ratio in the MD is not more than about 16. In another embodiment, the draw ratio is not more than about 7.

When stretching is arranged in the transverse direction, the stretching draw ratio in the transverse direction (TD) is generally not less than about 2. In another embodiment, the draw ratio in the TD is not less than about 2.5 and in yet another embodiment is not less than about 3.0. In another aspect, the stretching draw ratio in the TD is not more than about 16. In another embodiment, the draw ratio is not more than about 7. In yet another embodiment the draw ratio is not more than about 5.

The biaxial stretching, if used, may be accomplished simultaneously or sequentially. With the sequential, biaxial stretching, the initial stretching may be performed in either the MD or the TD.

The microlayer film of the invention may be pretreated to prepare the film for the subsequent stretching operations. The pretreatment may be done by annealing the film at elevated temperatures, by spraying the film with a surface-active fluid (such as a liquid or vapor from the surface-active material employed to surface-modify the filler material or modify the components of the film), by modifying the physical state of the microlayer film with ultraviolet radiation treatment, an ultrasonic treatment, e-beam treatment, or a high-energy radiation treatment. Pretreatment may also include perforation of the film, generation of z-directional channels of varying size and shapes, penetrating through the film thickness. In addition, the pretreatment of the microlayer film may incorporate a selected combination of two or more of the techniques. A suitable stretching technique is disclosed in U.S. Pat. No. 5,800,758, the disclosure of which is hereby incorporated in its entirety.

The film with microlayers may be post-treated. The post-treatment may be done by point bonding the film, by calendaring the film, by sealing edges of the film, and by perforation of the film, including generation of channels penetrating through the film thickness.

The microlayer film of this invention may be laminated to one or more nonwoven webs. The nonwoven webs may be spunbond webs, meltblown webs, bonded carded webs, airlaid or wetlaid webs, or other nonwoven webs known in the art.

Accordingly, the microlayer film of this invention is suitable for use as an elastic component in absorbent personal care items including diapers, adult incontinence products, feminine care absorbent products, training pants, and health care products such as wound dressings. The microlayer film of this invention may also be used to make surgical drapes and surgical gowns and other disposable garments.

Lamination may be accomplished using thermal or adhesive bonding as known in the art. Thermal bonding may be accomplished by, for example, point bonding.

The adhesive may be applied by, for example, melt spraying, printing or meltblowing. Various types of adhesives are available including those produced from amorphous polyalphaolefins and ethylene vinyl acetate-based hot melts.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

As mentioned above, the engineering tensile peak force and stress (force at failure peak load divided by the cross-sectional are of the original specimen) is tested in the machine direction orientation according to ASTM-D882-02. The “single sheet caliper” is measured as one sheet using an EMVECO 200-A Microgage automated micrometer (EMVECO, Inc., Oregon). The micrometer has an anvil diameter of 2.22 inches (56.4 millimeters) and an anvil pressure of 132 grams per square inch (per 6.45 square centimeters) (2.0 kPa). The hysteresis was obtained by cycling the samples between zero and 150% elongation. The MTS Sintech 1/S screw driven frame was used for the acquisition of the hysteresis data. The cross-head was displaced at a rate of 20 in./min. The samples were cycled 3 times. The data acquired was at a rate of 100 data points per cycle. The loading and unloading energy were calculated by integrating the area under the respective curves. Percentage hysteresis was then calculated as (Area under the loading curve minus Area under the unloading curve) divided by the Area under the loading curve.

Basis weight is the mass per unit area of film and is generally expressed in units of grams per square meter.

Electron micrographs may be generated by conventional techniques that are well known in the imaging art. In addition, samples may be prepared by employing well known, conventional preparation techniques. For example, the imaging of the cross-section surfaces may be performed with a JEOL 6400 SEM.

The inventors have found that layering two elastomeric resins, via multi-layer die assemblies (i.e., referred to as “splitters”), can result in a film having higher modulus, strength and lower hysteresis than dry blending a film with equivalent composition (i.e., equivalent resin weight percentages). In addition, it has been found that increasing the number of layers for a given film gauge, further improves said properties.

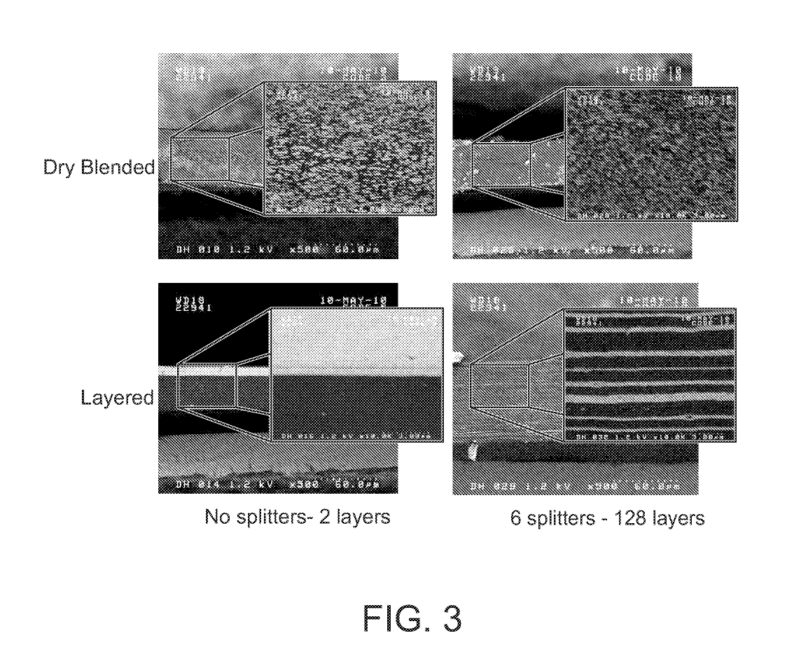

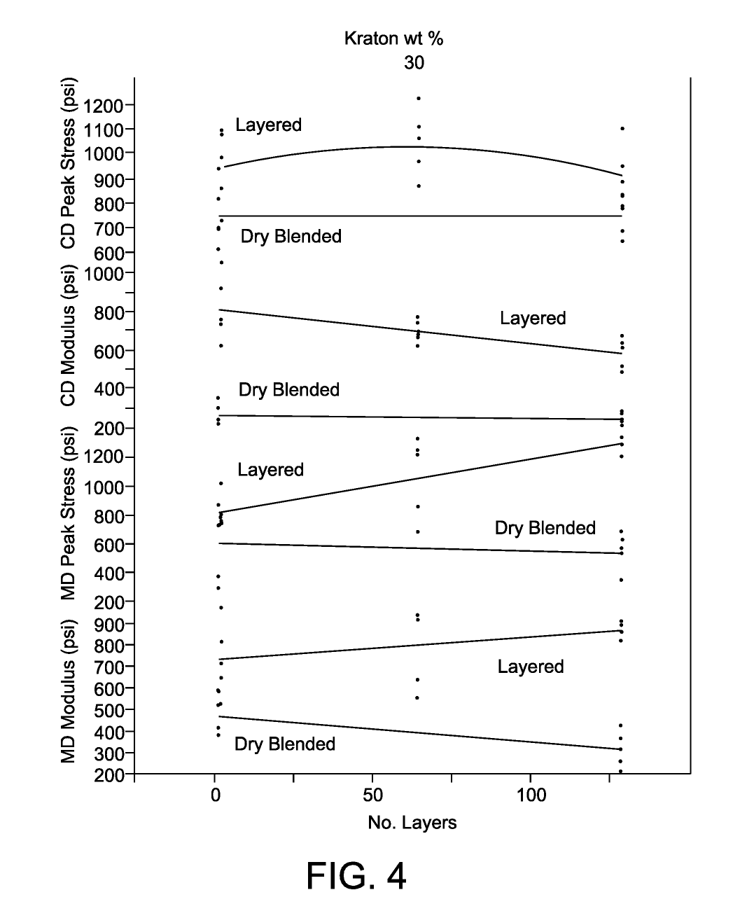

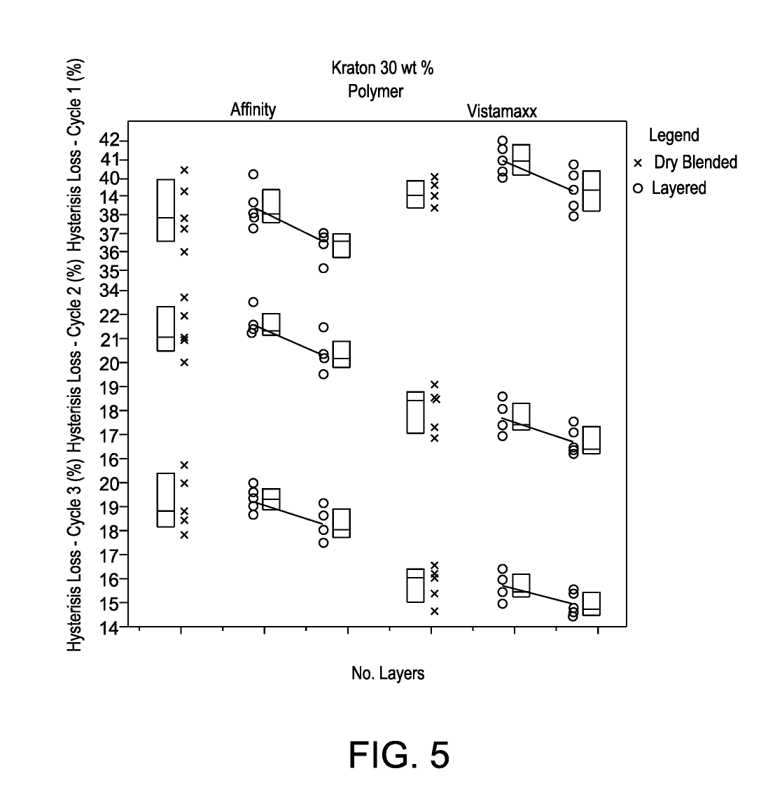

Films composed of 70 wt % elastomeric polyolefin polymer (Affinity elastomer available from The Dow Chemical Company or Vistamaxx elastomer available from ExxonMobil Chemical Company) and 30 wt % SEBS styrenic block copolymer composition available from Kraton were investigated. Control films were produced with a blend of the two resins at the target composition, both with (see FIG. 3 upper right) and without (see FIG. 3 upper left) the presence of splitters. Films layered with the two compositions were produced without splitters (see FIG. 3 lower left), with five splitters, and with six splitters (see FIG. 3 lower right), resulting in 2-layer, 64-layer, and 128-layer films, respectively. In all cases a film basis weight of 40 gsm was targeted. Resulting films were tested for MD and CD peak stress, modulus, and strain to break under simple tension as shown in FIG. 4. It is noted that higher values of all measured properties were obtained for the layered films. Hysteresis was measured via 3-cycle testing as is depicted in FIG. 5. In particular, it is noted that hysteresis improves as the number of microlayers increases.

For the films with the Dow Affinity resin, MD and CD modulus were found to increase by layering the two resins versus blending the resins, with significance at >95% confidence. Moreover, MD modulus and peak stress were found to increase as the number of layers increased, with significance at >80% confidence.

Hysteresis of the layered films under cyclical tension was found to be directionally lower than that of blended films. Moreover, as the number of layers increased, hysteresis decreased further. Thus, combining the elastomeric polyolefin composition and the styrenic block copolymer composition in a layered fashion, as compared to blending equivalent amount of the two components, resulted in statistically differentiable mechanical performance.

For the films with the ExxonMobil resin, MD and CD modulus were found to increase by layering the two resins versus blending the resins, with significance at >95% confidence. Moreover, MD and CD modulus were found to increase as the number of layers increased, with significance at 95% and 80% confidence, respectively. MD peak stress was also found to increase with number of layers with significance 80% confidence. Hysteresis was unchanged by layering versus blending. Thus, combining the elastomeric polyolefin composition and the styrenic block copolymer composition in a layered fashion, as compared to dry blending equivalent amount of the two components, results in statistically differentiable mechanical performance.

The obtained experimental results demonstrate that microlayer films of thermoplastic polymer having alternating layers of olefinic elastomer compositions and styrenic block copolymer compositions demonstrate improved mechanical properties over similar films made with blends of olefinic elastomer compositions and styrenic block copolymer compositions.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A multi-microlayer film comprising a plurality of alternating coextruded first and second microlayers, wherein the first microlayers comprise an elastomeric polyolefin polymer composition, and further wherein the second microlayers comprise a styrenic block copolymer composition.

2. The multi-microlayer film of claim 1, wherein the elastomeric polyolefin polymer composition comprises from about 40 wt. % to about 95 wt. % of a metallocene catalyzed elastomer.

3. The multi-microlayer film of claim 1, wherein the elastomeric polyolefin polymer composition comprises from about 40 wt.% to about 95 wt.% of a polymer selected from the group consisting of polyethylene, polypropylene and other alpha-olefin homopolymers and copolymers having density less than about 0.89 grams/cc.

3. The multi-microlayer film of claim 1, wherein the styrenic block copolymer composition comprises from about 5 wt. % to about 60 wt. % of a styrenic block copolymer.

4. The multi-microlayer film of claim 1, wherein the elastomeric polyolefin polymer composition comprises from about 40 wt.% to about 95 wt.% of the multi-microlayer film and the styrenic block copolymer composition comprises from about 5 wt. % to about 60 wt. % of the multi-microlayer film.

5. The multi-microlayer film of claim 1, wherein each microlayer has a thickness of from about 0.05 microns to about 150 microns.

6. The multi-microlayer film of claim 1, wherein the multi-microlayer film has a thickness from about 5 to about 500 microns.

7. The multi-microlayer film of claim 1, wherein the multi-microlayer film comprises from about 8 to about 4,000 microlayers.

8. The multi-microlayer film of claim 1, wherein the multi-microlayer film has an MD modulus greater than 20% greater than a non-layered film with the same basis weight of elastomeric polyolefin polymer and styrenic block copolymer.

9. The multi-microlayer film of claim 1, wherein the multi-microlayer film has a CD modulus greater than 20% greater than a non-layered film with the same basis weight of elastomeric polyolefin polymer and styrenic block copolymer.

10. A nonwoven composite comprising a nonwoven material and the multi-microlayer film of claim 1 laminated to the nonwoven material.

11. An absorbent article comprising an outer cover, a bodyside liner joined to the outer cover, and an absorbent core positioned between the outer cover and the bodyside liner, wherein the absorbent article includes the nonwoven composite of claim 10.

12. A method of making a multi-microlayer film, the method comprising the steps of
providing an elastomeric polyolefin polymer composition and a styrenic block copolymer composition;
coextruding the elastomeric polyolefin polymer composition and the styrenic block copolymer composition;
splitting the elastomeric polyolefin polymer composition and the styrenic block copolymer composition into multiple alternating layers; and,
forming the multiple alternating layers into a multi-microlayer film having alternating coextruded microlayers.

13. The method of claim 12, wherein the elastomeric polyolefin polymer composition comprises from about 10 wt. % to about 50 wt. % of a metallocene catalyzed elastomer.

14. The method of claim 12, wherein the styrenic block copolymer composition comprises from about 10 wt. % to about 50 wt. % of a styrenic block copolymer.

15. The method of claim 12, wherein the elastomeric polyolefin polymer composition comprises from about 50 wt.% to about 90 wt.% of the multi-microlayer film and the styrenic block copolymer composition comprises from about 10 wt. % to about 50 wt. % of the multi-microlayer film.

16. The method of claim 12, wherein each microlayer has a thickness of from about 0.05 microns to about 150 microns.

17. The method of claim 12, wherein the multi-microlayer film has a thickness from about 5 to about 500 microns.

18. The method of claim 12, wherein the multi-microlayer film comprises from about 8 to about 4,000 microlayers.

19. The method of claim 12, wherein the multi-microlayer film has an MD modulus greater than 20% greater than a non-layered film with the same basis weight of elastomeric polyolefin polymer and styrenic block copolymer.

20. The method of claim 12, wherein the multi-microlayer film has an CD modulus greater than 20% greater than a non-layered film with the same basis weight of elastomeric polyolefin polymer and styrenic block copolymer.
